(19) United States
(12) Patent Application Publication
(10) Pub. No.: US 2016/0253709 A1
(43) Pub. Date: Sep. 1, 2016

(54) ONLINE ADVERTISEMENT FORECASTING USING TARGETED MESSAGES

(71) Applicant: LinkedIn Corporation, Mountain View, CA (US)

(72) Inventors: Jieying Chen, Sunnyvale, CA (US); Tingting Cui, Mountain View, CA (US); Zhifeng Deng, Mountain View, CA (US); Siyu You, Santa Clara, CA (US); Deepak Kumar, Mountain View, CA (US); Guangyu Dong, Santa Clara, CA (US); Sanjay Kshetramade, Fremont, CA (US); Jan Schellenberger, Belmont, CA (US)

(21) Appl. No.: 14/642,586

(22) Filed: Mar. 9, 2015

Related U.S. Application Data
(60) Provisional application No. 62/126,119, filed on Feb. 27, 2015.

(51) Int. Cl. G06Q 30/02; G06Q 50/00

(52) U.S. Cl. CPC G06Q 30/0269; G06Q 30/0264; G06Q 30/0261; G06Q 50/01

(57) ABSTRACT

Techniques for forecasting for an advertisement campaign are described. A personalized communication system can receive a request for an advertisement campaign on a social network. The request can have a member attribute and a time frame. The personalized communication system can access member data and behavior data from the social network. Additionally, the personalized communication system can determine a target group based on the member data and the member attribute. Furthermore, the personalized communication system can calculate a number of unique visitors to the social network from the target group based on the member attribute, the time frame, and a frequency cap. Subsequently, the personalized communication system can forecast a number of messages for the first advertisement campaign based on the calculated number of unique visitors, the behavior data, and the time frame.

### PRIORITY APPLICATION

This application claims the priority benefit of U.S. Provisional Application No. 62/126,119, filed Feb. 27, 2015, which is incorporated by reference herein in its entirety.

### TECHNICAL FIELD

This application relates generally to the technical field of internet marketing and, in one specific example, to forecasting a number of potential members in a social network receiving a targeted message from an advertiser based on a frequency capping.

### BACKGROUND

Online advertising is a form of marketing and advertising which uses the Internet to deliver promotional marketing messages to consumers. Online marketing channels include email marketing, search engine marketing, social media marketing, mobile advertising, and so on.

While email marketing remains one of the dominant online advertising channels, list maintenance, content personalization, over-saturation, and mobile optimization remain among the top email marketing challenges. Meanwhile, mobile devices are playing an increasingly important role in reaching prospects, despite mobile optimization hurdles.

Additionally, online advertising channels have become saturated, and as a result, a recipient may not see an advertisement or may simply ignore an advertisement. To ensure an effective advertisement campaign, a social network can incorporate techniques to increase visibility of the advertisement to its members.

In some instances, a social network can utilize its platform to connect advertisers directly with members on the social network to ensure that important messages are received by the intended recipient. For example, a personalized, one-to-one communication between the advertiser and the member can increase the likelihood that a message is received and read by the recipient.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network, according to various embodiments.

FIG. 2 a block diagram illustrating various modules of a social network service, according to various embodiments.

FIG. 3 is a flowchart illustrating a method of forecasting for an advertisement campaign, according to various embodiments.

FIG. 4 is a user interface diagram illustrating an example of a forecast for an advertiser, according to various embodiments.

FIG. 5 is a graph illustrating a forecasting model with a frequency cap, according to various embodiments.

FIG. 6 is a flowchart illustrating a method for determining a target group for an advertisement campaign, according to various embodiments.

FIG. 7 is a graph illustrating forecasting simulations that incorporate a frequency cap based on another advertisement campaign in the forecasting model, according to various embodiments.

FIG. 8 is a flowchart illustrating a method for calculating the number of unique visitors for an advertisement campaign, according to various embodiments.

FIG. 9 is a graph illustrating a forecasting simulation that incorporates a frequency cap with a discount factor, according to various embodiments.

FIG. 10 is a flowchart illustrating a method for forecasting a number of group messages for an advertisement campaign, according to various embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems are directed to techniques for forecasting a target audience for an online advertisement campaign. More specifically, the present disclosure relates to methods, systems, and computer program products for calculating a number of advertisement messages based on a number of unique visitors to a social network. In some instances, the number of unique visitors receiving the advertisement message is further based on a predetermined frequency cap.

Social networks can allow advertisers to send targeted members of the social network personalized messages. Additionally, each member of the social network can have a limit for the number of personalized messages received for a predetermined amount of time. Advertisement forecasting framework can estimate the number of targeted members an advertiser can contact based on parameters such as locations, member attributes, industry, and so on. Current forecasting frameworks can provide estimates based on temporal correlations and structures in the time series. However, current forecasting frameworks may not be able to accurately calculate a target audience based on parameters associated with a personalized communication module. Parameters associated with the personalized communication module can include a frequency cap, a discounting factor, a calculated ratio based on member attributes, restrictions based other advertisement campaign, and so on.

For example, a social network can include a personalized communication module for an advertiser and a member of the social network to ensure that important messages are received and read by the recipient. The personalized communication module can send targeted messages directly to members targeted by an advertiser based on the members' attributes.

Additionally, the personalized communication module can send a targeted message to a member's inbox in the social network. Moreover, a frequency cap can be associated with each member. The frequency cap can be a limit (e.g., maximum allowed) on the number of targeted messaged received by a member over a predetermined amount of time. Furthermore, to increase the likelihood that the message is seen by the member, the personalized communication module can deliver the message when the member is active (e.g., login) on the social network. By delivering the message when the member is active, the personalized communication module reduces the occurrence of messaging bouncing back, and reduces the occurrence of messages being filtered out by a spam blocker.

The personalized communication module can send personalized letters directed to an advertiser's targeted audiences. As opposed to the cluttered inboxes used by traditional email marketing, an advertiser can be fairly confident that its target audience will see the message. In some instances, the personalized communication module can alert members when a target message has been received. For example, the social network can display a prominent notification on the member's homepage when a member receives a targeted message. Additionally, given that the number of targeted messages a member receives is limited, other advertisers can be restricted from contacting the member, and thus the advertisement is less likely to he cluttered with other advertisements.

As a result, the personalized communication module described herein overcomes limits associated with current advertisement channels, such as ordinary email communication, which have become saturated. The personalized communication module can help boost conversion with targeted product and service promotions, thought leadership content, personalized invitations to events and conferences, and so on. In some instances, the personalized communication module can help reach active members through tailored messages with almost one hundred percent deliverability rate. In comparison to current advertisement channels, the personalized communication module can better promote features and benefits of a product or service to a targeted group of potential buyers; better highlight the benefits of continued education for professionals; and efficiently introduce groups and professional communities focused on a specific topic or industry.

Additionally, unlike conventional emails campaigns, the targeted messages leverage the credibility of the social network, and thus can increase the likelihood for the message to be opened and read. Furthermore, with granular profile-based targeting (e.g., based on member attributes), advertisers specify recipients based on member attributes (e.g., geography, job role, group membership, sex, company size, etc.) to ensure that the message reaches a specific target audience.

Furthermore, given that the benefits of the personalized communication module, each individual message may be expensive in comparison to conventional email messages. Therefore, an accurate and real-time forecast of the target audience can be beneficial for the advertiser. As previously described, the advertisers can use the personalized communication module to send out a personalized message to the target audiences. The forecasting techniques described herein can provide an advertisement inventory supply forecast to advertisers. For example, an advertiser can get a real-time estimate of the number of possible members to receive the personalized messaged if the advertisement campaign targets members based on locations, gender or industry, and so on.

Techniques described herein can forecast the number of members in a social network targeted by a specific advertisement campaign. Additionally, the forecast can be based on factors such as a frequency cap, a discounting factor, calculated ratios based on member attributes, other advertisement campaigns, and so on

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

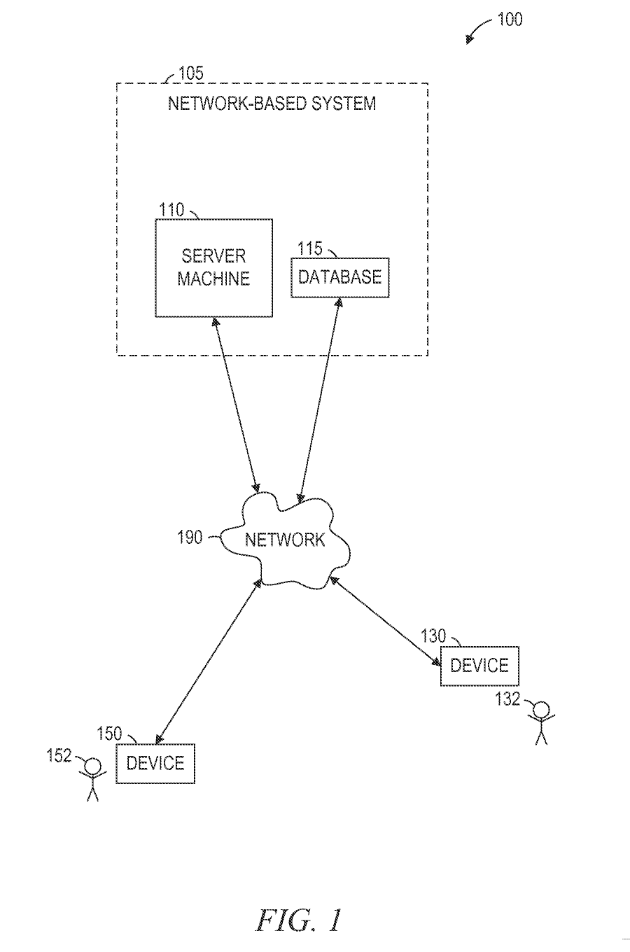

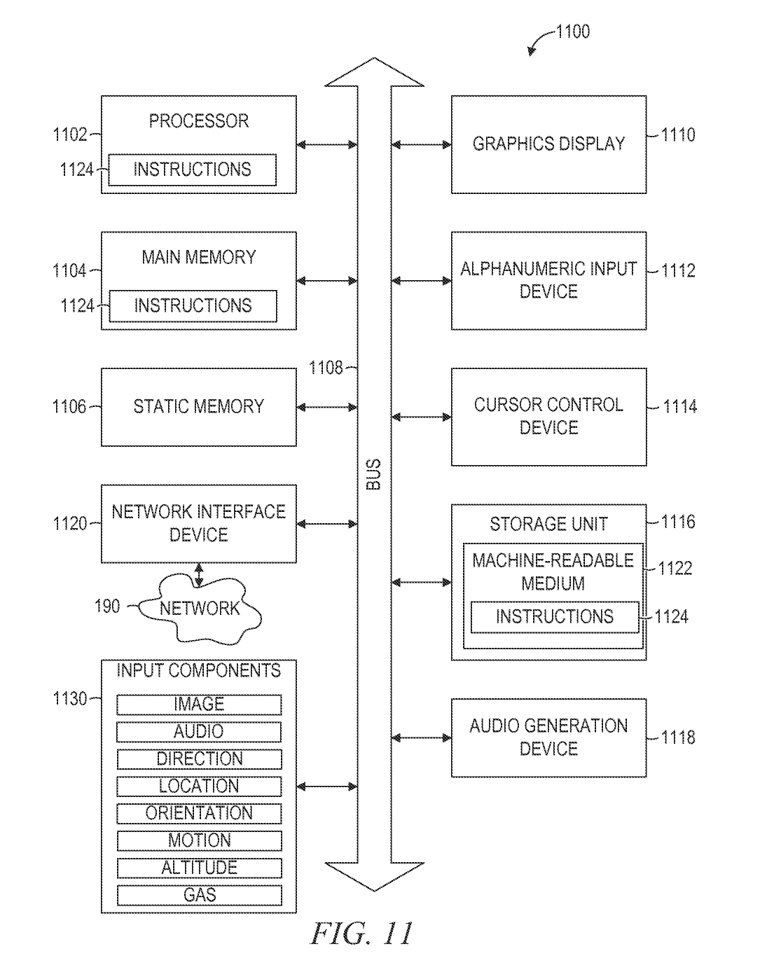

FIG. 1 is a network diagram illustrating a network environment 100 suitable for a social network service, according to some example embodiments. The network environment 100 includes a server machine 110, a database 115, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150). The database 115 can store member data (e.g., profile data, social graph data) for the social network service. The server machine 110, the first device 130, and the second device 150 may each be implemented in a computer system, in whole or in part, as described below with respect to FIG. 11.

Also shown in FIG. 1 are the users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e,g., a smart watch or smart glasses) belonging to the user 152.

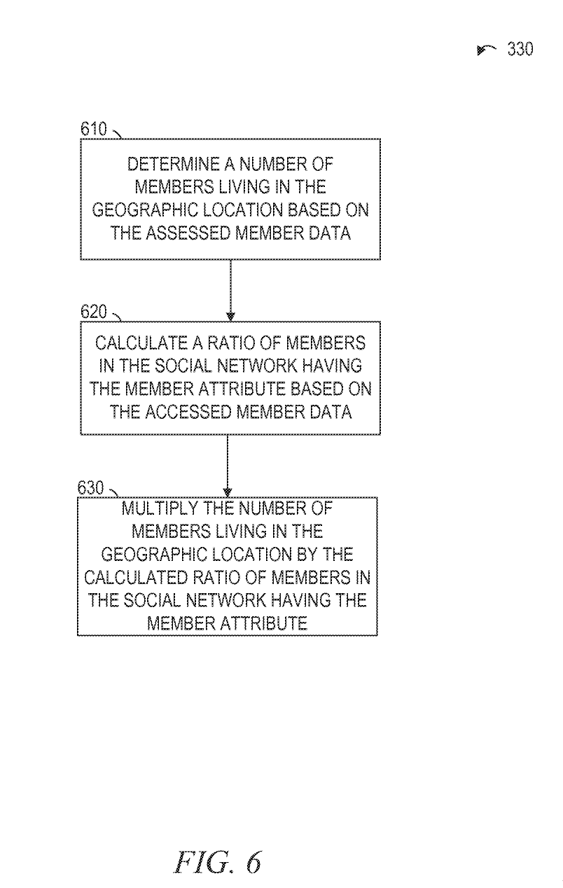

Any of the machines, databases 115, or devices 130, 150 shown in FIG. 1 may be implemented in a general-purpose computer modified (e.g., configured or programmed) by software (e.g., one or more software modules) to be a special-purpose computer to perform one or more of the functions described herein for that machine, database 115, or device 130, 150. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 illustrated in FIG. 1 may be combined into a single machine, database 115, or device 130, 150, and the functions described herein tier any single machine, database 115, or device 130, 150 may be subdivided among multiple machines, databases 115, or devices 130, 150.

The network 190 may be any network that enables communication between or among machines, databases 115, and devices (e.g., the server machine 110 and the device 130). Accordingly, the network 190 may be a wired network, a wireless network. (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

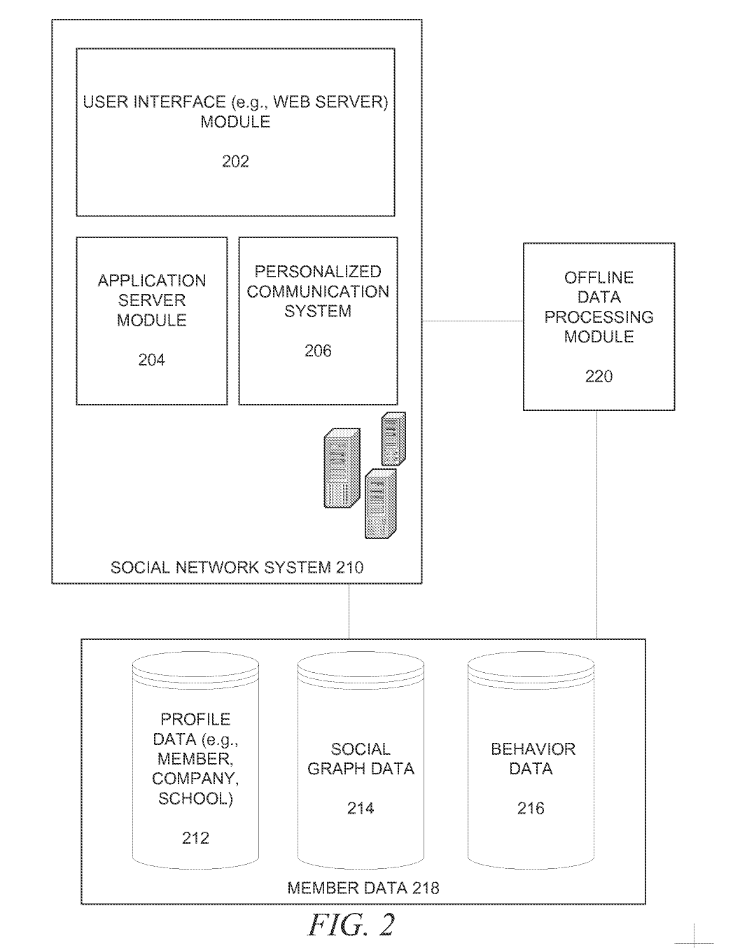

FIG. 2 is a block diagram illustrating components of a social network system 210, according to some example embodiments. The social network system 210 is an example of a network-based system 105 of FIG. 1. The social network system 210 can include a user interface module 202, an application server module 204, and a personalized communication module 206, all configured to communicate with each other (e.g., via a bus, shared memory, or a switch).

Additionally, the social network system 210 can communicate with the database 115 of FIG. 1, such as a database storing member data 218. The member data 218 can include profile data 212, social graph data 214, and behavior data 216. For example, using profile data 212, and behavior data 216, the forecast of a potential audience for an advertisement campaign can be calculated based on the member data 218 of the social network system 210.

In some instances, the personalized communication module 206 can be configured to process data offline or periodically using an offline data processing module 220. For example, the offline data processing module 220 can include Hadoop servers that access the member data 218 periodically (e.g., on a nightly basis). Processing the member data 218 may be computationally intensive; therefore, due to hardware limitations and to ensure reliable performance of the social network, some of the calculation and forecasting can be done offline. For example, some of the parameters (e.g., discounting factor, ratio based on a member attribute) can be calculated offline. Therefore, these parameters can be inputted in the forecast model in real-time in order to almost instantaneously present an estimated cost to an advertiser for an advertisement campaign.

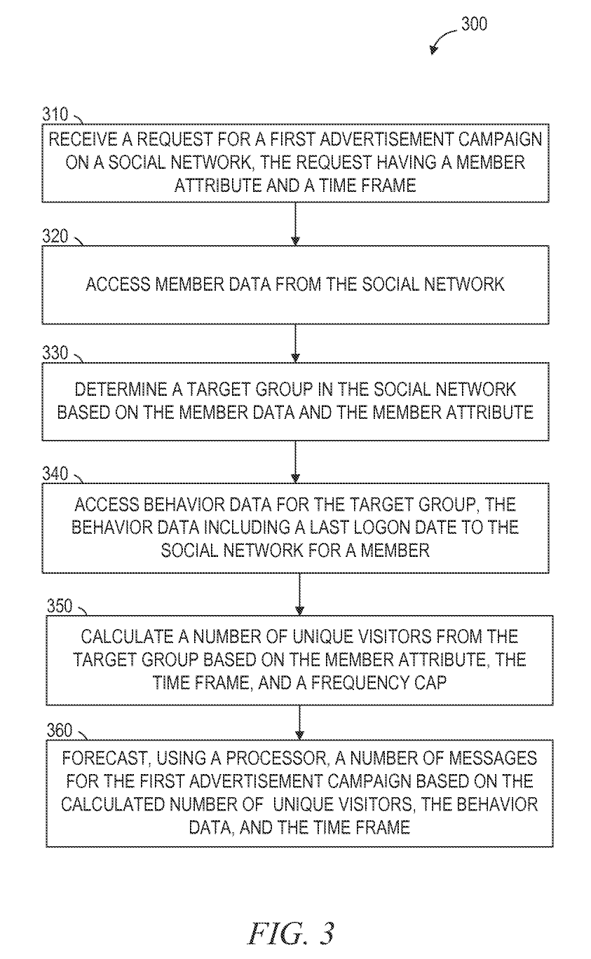

As will be further described with respect to FIGS. 3-6, the personalized communication module 206, in conjunction with the user interface module 202 and the application server module 204, can forecast the number of messages in the social network system 210.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database 115, or device 130, 150 may be distributed across multiple machines, databases 115, or devices 130, 150.

As shown in FIG. 2, database 115 can include several databases for member data 218. The member data 218 includes a database for storing the profile data 212, including both member profile data and profile data 212 for various organizations. Additionally, the member data 218 can store the social graph data 214 and the behavior data 216.

In some embodiments, the member data 218 may be processed (e.g., real-time, background/offline) using the personalized communication module 206 to forecast a number of messages for an advertisement campaign based on a frequency cap and the number of daily unique visitors.

The profile data 212 can include member attributes used in the forecasting models for the personalized communication module 206. For instance, with many social network services, when a user 132, 152 registers to become a member, the member is prompted to provide a variety of personal and employment information to be displayed in the member's personal web page. Such information is commonly referred to as member attributes. The member attributes that is commonly requested and displayed as part of a member's profile includes the member's age, birthdate, gender, interests, contact information, residential address, home town and/or state, spouse and/or family members, educational background (e.g., schools, majors, matriculation and/or graduation dates, etc.), employment history, office location, skills, professional organizations, and so on,

In some embodiments, the member attributes may include the various skills that each member has indicated he or she possesses. Additionally, the member attributes may include skills for which a member has been endorsed.

With certain social network services, such as some business or professional network services, the member attributes may include information commonly included in a professional resume or curriculum vitae, such as information about a person's education, the company at which a person is employed, the location of the employer, an industry in which a person is employed, a job title or function, an employment history, skills possessed by a person, professional organizations of which a person is a member, and so on.

Another example of the profile data 212 can include data associated with a company page. For example, when a representative of an entity initially registers the entity with the social network service, the representative may be prompted to provide certain information about the entity. This information may be stored, for example, in the database 115 and displayed on an entity page. This type of profile data 212 can also be used in the forecasting models described herein.

Additionally, social network services provide their users 132, 152 with a mechanism for defining their relationships with other people. This digital representation of real-world relationships is frequently referred to as a social graph.

In some instances, the social graph data 214 can be based on a member's presence within the social network service. For example, consistent with some embodiments, a social graph is implemented with a specialized graph data structure in which various members are represented as nodes connected by edges. The social graph data 214 can be used by the personalized communication module 206 to determine the authenticity of a member's profile page. In some instances, the social graph data 214 can be used to calculate the parameters (e.g., discounting factor, ratio based on a member attribute) for the forecasting models.

In addition to hosting a vast amount of social graph data 214, many social network services maintain behavior data 216. The behavior data 216 can include an access log of when a member has accessed the social network system 210, profile page views, entity page views, newsfeed postings, and clicking on links on the social network system 210. For example, the access log can include the last logon date, the frequency of using the social network system 210, and so on.

Additionally, the behavior data 216 can include information associated with applications and services that allow members the opportunity to share and receive information, often customized to the interests of the member. In some embodiments, members may be able to self-organize into groups, or interest groups, organized around subject matter or a topic of interest.

FIG. 3 is a flowchart illustrating operations of the personalized communication module 206 in performing a method 300 for forecasting a number of potential members for an advertisement campaign, according to various embodiments. Operations in the method 300 may be performed by the network-based system 105, using modules described above with respect to FIG. 2. As shown in FIG. 3, the method 300 includes operations 310, 320, 330, 340, 350, and 360.

At operation 310, the personalized communication module 206 can receive a request for a first advertisement campaign on the social network system 210. The request can include a member attribute and a time frame. The request can be received with a user input on the first device 130 by an advertiser (e.g., first user 132) using the network 190. A member attribute can include job title, a job skill, age, birthdate, gender, interests, contact information, residential address, educational background (e.g., schools, majors, matriculation and/or graduation dates, etc.), employment history, office location, skills, professional organizations, salary, and so on.

For example, the request can be for a 30-day advertisement campaign targeting software engineers living in California. In this example, the member attribute is software engineering, or members living in California. In some instances, the request can include a geographic location, which in this example is California. Continuing with the example, the timeframe is 30 days. Additionally, the time frame can include a start date and an end date.

At operation 320, the personalized communication module 206 can access member data 218 from the social network system 210. In some instances, the personalized communication module 206 just accesses the profile data 212 in order to obtain information relating to the member attributes. The member data 218 can be accessed from the database 115 using the network 190.

The personalized communication module 206 can access the member data 218, including the profile data 212, social graph data 214, and behavior data 216. For example, the profile data 212 includes the member attributes, which can be identified by the personalized communication module 206 to be similar to the received member attributes at operation 310. The personalized communication module 206 can identify a degree of similarities between the received member attribute at operation 310 and the accessed member data 218 at operation 320 to determine a target group.

Continuing with the example above, the personalized communication module 206 can query the database 115 to retrieve profiles that correspond to the request tier the advertisement campaign. For example, profiles of members of the social network system 210 that are associated with being a software engineering are retrieved. A member listing software engineer for a job title can be associated as being a software engineer.

At operation 330, the personalized communication module 206 can determine a target group in the social network based on the accessed member data 218 and the received member attribute. A processor in server machine 110 or the first device 130 can perform operation 330. FIG. 6 further describes determining a target group in the social network, according to various embodiments.

At operation 340, the personalized communication module 206 can access behavior data 216 for the target group. The behavior data 216 can include a last logon date to the social network system 210 for a member. The behavior data 216 can be accessed from the database 115 using the network 190.

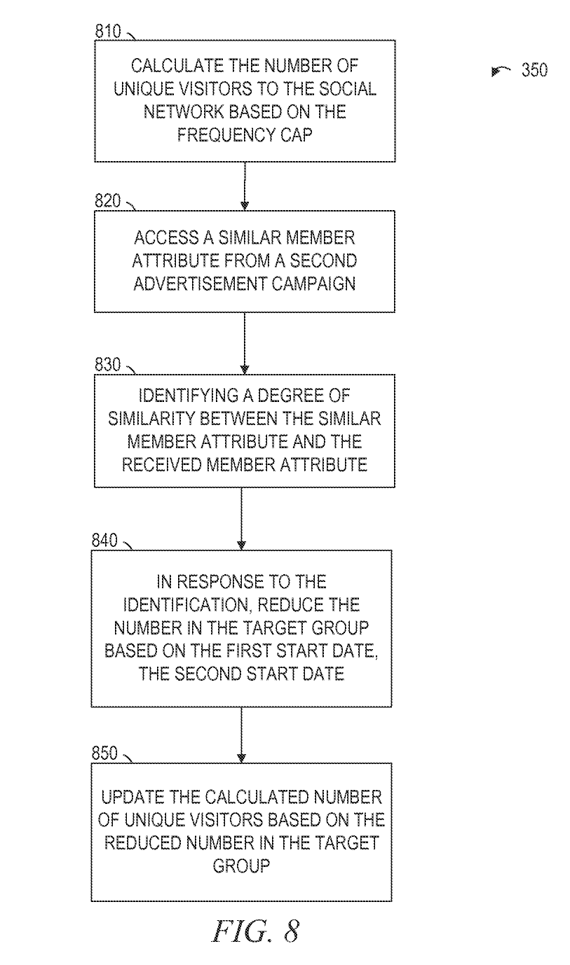

At operation 350, the personalized communication module 206 can calculate a number of unique visitors for the social network based on the member attribute, the time frame, and a frequency cap. In some instances, the number of unique visitors can be calculated for various time periods, such as hourly, daily, weekly, monthly, and so on. The member attribute and the time frame can be received from an advertiser at operation 310. The calculating at operation 350 can be performed using a processor in the server machine 110 or a processor in the first device 130. FIG. 8 further describes calculating a number of daily unique visitors, according to various embodiments.

The frequency cap can correspond to a maximum number of messages that a member receives during a predetermined amount of time. For example, the frequency cap can be set so that a member can only receive a targeted message from an advertiser once every sixty days. In some instances, the frequency cap can be based on the received member attributes. For example, the frequency cap for a member who is a current executive at a large corporation can be lower than for a member that is actively seeking job employment. The frequency can be predetermined by the social network, or an operator of the social network system 210. Alternatively, the frequency cap can be dynamic and determined using machine learning techniques in order to optimize the probability that the target messaged is open by the member.

At operation 360, the personalized communication module 206 can forecast a number of messages for the first advertisement campaign based on the calculated number of daily visitors, the behavior data 216, and the time frame. In some instances, the forecasting can also be based on the frequency cap. The number of daily unique visitors is calculated at operation 350. The time frame is received at operation 310. The behavior data 216 can be accessed from database 115 at operation 340. The forecasting at operation 360 can be performing using a processor in the server machine 110 or a processor in the first device 130. FIG. 110 further describes forecasting the number of messages for the first advertisement campaign, according to various embodiments.

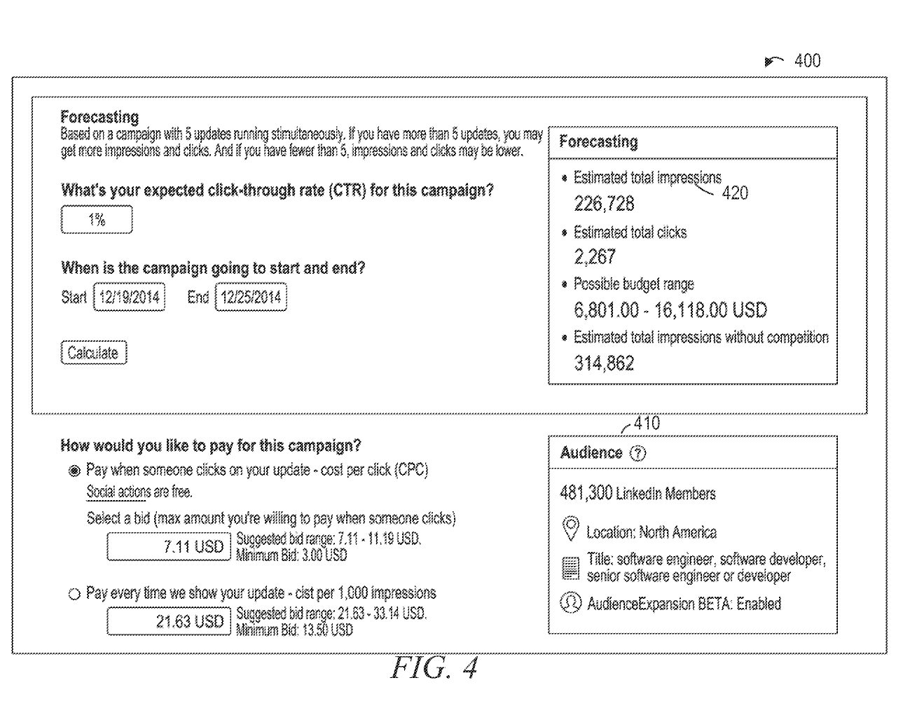

As illustrated in FIG. 4, the personalized communication module 206, using user interface module 202, can further cause a presentation of the number of messages (e.g., impressions) for the first advertisement campaign on a display of a device 130, 150, according to various embodiments. Additionally, the presentation 400 can include an estimated audience 410 based on the forecast of method 300. The estimated audience 410 can correspond to the calculated unique visitors at operation 350. Moreover, the presentation 400 can include an estimated total number of impressions 420. The estimated total number of impressions 420 can correspond to the number of messages forecasted at operation 360.

Furthermore, the presentation 400 can be adjusted based on the device 130, 150. For example, the presentation 400 can be optimized for mobile viewing when the device 130, 150 is a mobile device. Alternatively, the presentation 400 can be optimized for desktop viewing when the device 130, 150 is a desktop computer. In some instances, depending the optimization, different user interfaces having different features can presented on the display of the device 130, 150. The user interface module 202 and personalized communication module 206 in the social network system 210 are configured to communicate with each other (e.g., via a bus, shared memory, or a switch) to cause the presentation 400 of the forecasting data.

In some instances, the advertisement campaign may just target mobile device users or desktop users. Therefore, the behavior data 216 accessed at operation 340 can include mobile device usage data or desktop device usage data depending on the advertisement campaign. Furthermore, a forecasted number of potential members or messages can correspond to mobile device users only or desktop users only.

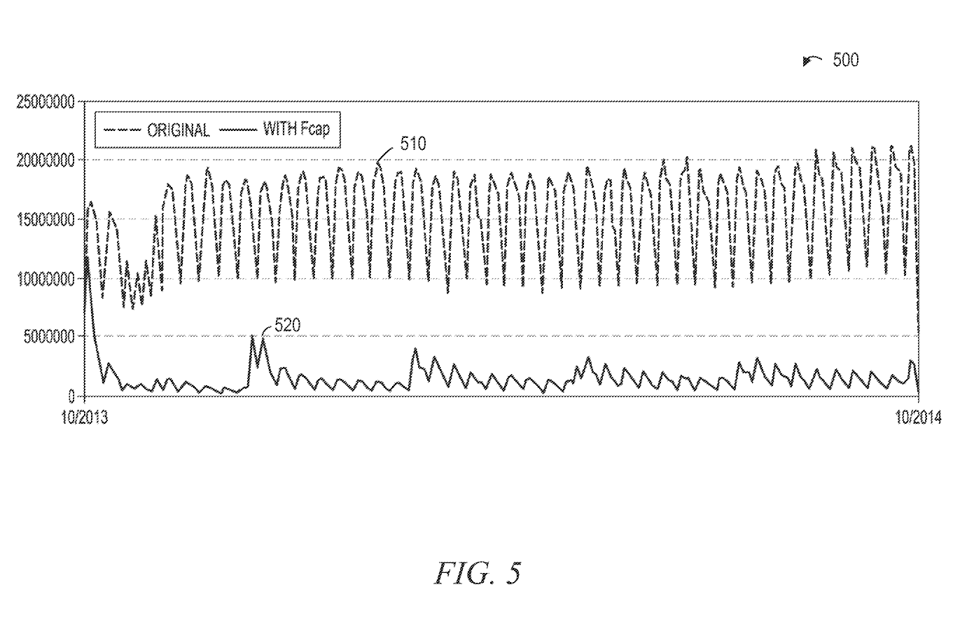

The number of potential members or messages can be forecasted based on the simulation graph illustrated in FIG. 5.

FIG. 5 illustrates a simulation graph 500 to describe forecasting simulations when incorporating a frequency cap in the forecasting model. The original forecast estimate 510 on the simulation graph 500 illustrates the number of unique visitors to the social network system 210 over a period of time. For example, the original forecast estimate 510 can correspond to the number of advertisement inventory for software engineers in California.

However, when the forecast simulation incorporates a frequency cap (“Fcap”) rule, the number of advertisement inventory is decreased as illustrated by the Fcap forecast estimate 520. For example, the frequency cap rule can be that a member can only receive a targeted message once every sixty days. The frequency cap rule can further incorporate a discounting factor and a correlation ratio, as previously discussed. Accordingly, for this example, only unique visitors, who have not visited the social network since the beginning of the advertisement campaign (e.g., discounting factor), and that have not received a targeted message from another advertisement campaign in the last sixty days can be included in the number of advertisement inventory.

FIG. 6 is a flowchart illustrating operations of the personalized communication module 206 in performing operation 330 for determining a target group in the social network based on the accessed member data 218 and the received member attribute, in accordance with various embodiments. Operation 330 may be performed by the network-based system 105, using modules described above with respect to FIG. 2. As shown in FIG. 6, the operation 330 includes operations 610, 620, and 630.

In some instances, the personalized communication module 206 can perform a base forecast and a correlation to determine the target group. For example, the advertiser can request a forecast of the advertisement inventory for people living in California and with job title software engineer. The base forecast can forecast the advertisement inventory for people living in California only. Additionally, the correlation ratio can be calculated by dividing the historic number of advertisement inventory of people living in California and with job title software engineer over the total number of advertisement inventory of people living in California. The historical numbers can be stored in database 115 and accessed by the personalized communication module 206 using network 190.

Continuing with the example, the base forecast multiplied by the correlation ratio can result in the target group of people living in California and with job title software engineer. In other words, the personalized communication module 206 forecasted the ads inventory of people living in California only and adjusted it with a correlation ratio.

At operation 610, the personalized communication module 206 can determine a number of members living in the geographic location based on the accessed member data 218. In the previous example, the geographic location is California. The accessed member data 218 can include historic number of advertisement inventory for people living in California.

At operation 620, the personalized communication module 206 can calculate a ratio of members in the social network having the member attribute based on the accessed member data 218. In the previous example, the member attribute is having a job title as a software engineer. Therefore, the personalized communication module 206 can determine the correlation ratio by dividing the historic number of advertisement inventory of people living in California and with job title software engineer over the total number of advertisement inventory of people living in California. The advertisement inventory numbers can be included in the accessed member data 218.

At operation 630, the personalized communication module 206 can multiply the number of members living in the geographic location by the ratio of members having the member attribute to determine the target group. Continuing with the example, the personalized communication module 206 multiplies the number of members living in California, determined in operation 610, by the ratio of software engineers in California, calculated in operation 620.

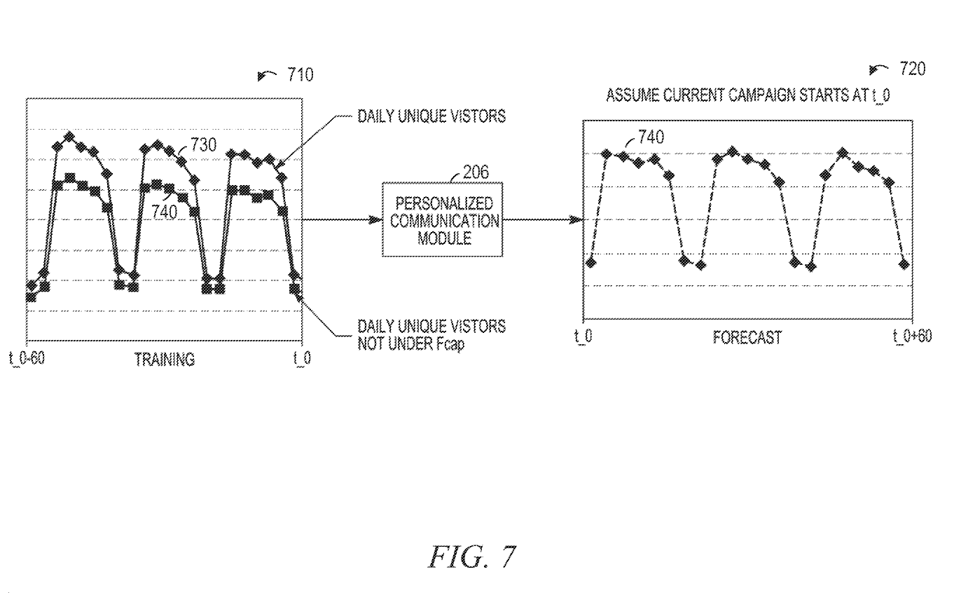

According to various embodiments, the calculated number of unique visitors may be reduced based on the frequency cap if another advertisement campaign is targeting the same group of members, as described in FIGS. 7-8.

FIG. 7 illustrates a first campaign simulation graph 710 and a second campaign simulation graph 720. The campaign simulation graphs 710, 720 describe forecasting simulations when incorporating a frequency cap (“Fcap”) based on another advertisement campaign in the forecasting model. The first campaign simulation graph 710 includes a daily unique visitors forecast 730 and a daily unique visitors not under Fcap forecast 740. The personalized communication module 206 can calculate the number of unique visitors by subtracting members that have already been targeted by another advertisement campaign from the daily unique visitors forecast 730. The calculated unique visitors based on the reduction can be the daily unique visitors not under Fcap forecast 740 illustrated in the simulation graphs 710, 720.

FIG. 8 is a flowchart illustrating operations of the personalized communication module 206 in performing operation 350 for calculating the number of unique visitors, in accordance with various embodiments. Operation 350 may be performed by the network-based system 105, using modules described above with respect to FIG. 2. As shown in FIG. 8, operation 350 includes operations 810, 820, 830, 840, and 850.

In some instances, the time frame received in the request for the advertisement campaign can include a first start date.

At operation 810, the personalized communication module 206 can calculate the number of unique visitors to the social network from the target group based on the frequency cap. For example, the frequency cap rule can be that a member can only receive a targeted message once every sixty days. Accordingly, only unique visitors, who match the member attribute, and that have not received a targeted message in the last sixty days can be included in the calculated number of unique visitors.

However, the number of unique visitors can be further reduced based on another advertisement campaign.

At operation 820, the personalized communication module 206 can access a similar member attribute from a second advertisement campaign. In some instances, only other advertisement campaigns (e.g., second advertisement campaign) that started before the first advertisement campaign are accessed to identify similar member attributes.

At operation 830, the personalized communication module 206 can identify a degree of similarity between the similar member attribute and the received member attribute. In some instances, the member attributes can match or have a degree of similarity. For example, the second advertisement campaign targeted software engineers, and the second advertisement campaign started before the first advertisement campaign.

At operation 840, in response to the identification, the personalized communication module 206 can reduce the number in the target group based on the first start date and the second start date. As illustrated by the simulation graphs 710, 720 of FIG. 7, the number of unique visitors is reduced because some of the members in the target group may have already been contacted based on the similar member attribute.

At operation 850, the personalized communication module 206 can update the calculated number of unique visitors based on the reduced number in the target group.

In some instances, once the number of unique visitors is reduced to factor in other advertisement campaigns, then a discounting factor is incorporated into the model in order to forecast the number of messages for the first advertisement campaign.

Given that a member can only be contacted based on the frequency cap, the number of messages each member receives can be restricted. To incorporate this restriction into the forecast, the personalized communication module 206 can calculate a discounting factor.

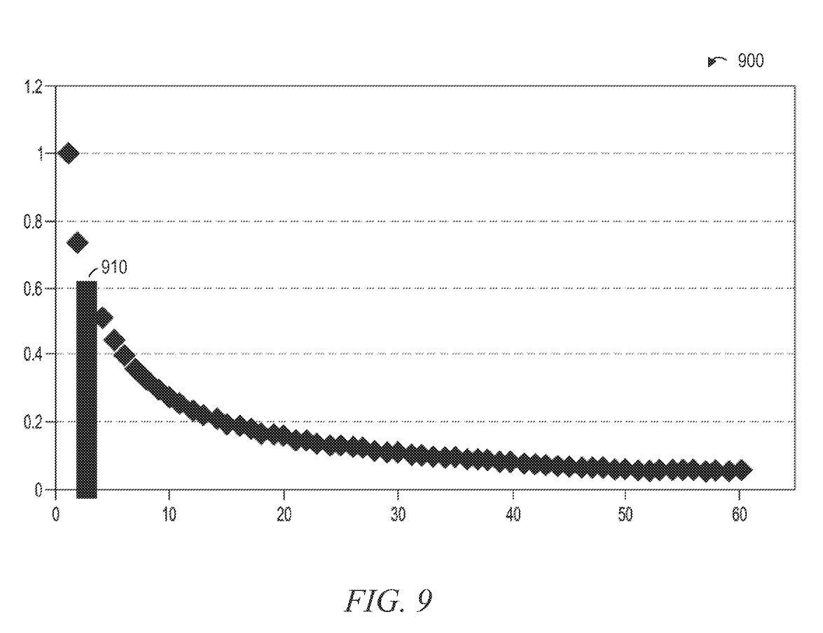

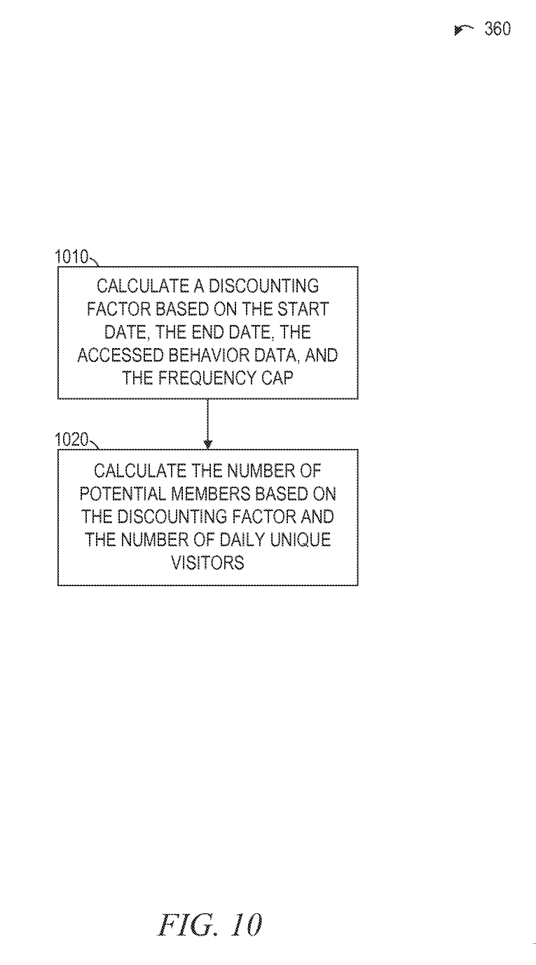

According to various embodiments, the number of messages forecasted based on the calculated number of unique visitors may be discounted based on the frequency cap, as described in FIGS. 9-10.

FIG. 9 illustrates a graph 900 of a discounting factor when the frequency cap limits that a member only receives one message every sixty days. For example, the number of targeted messages at day three can equal the number of unique visitors to the social network multiplied by the probability that it is a first arrival to the social network fur the unique visitor in the past three days. The bar 910 illustrate the probability of being the first arrival to the social network for the unique visitor in the last three days. In some instances, the probability and discount factor for FIGS. 9-10 can be calculated using a Poisson model.

Additionally, the discount factor may be further dependent on the inter-arrival distribution. A parametric approach or a non-parametric approach can be used to determine the inter-arrival distribution. The non-parametric approach can use an empirical histogram stored in database 115. The parametric approach can use a lognormal Poisson model and can be easy to extend per segment level.

FIG. 10 is a flowchart illustrating operations of the personalized communication module 206 in performing operation 360 for forecasting the number of messages for the first advertisement campaign, in accordance with various embodiments. Operation 360 may be performed by the network-based system 105, using modules described above with respect to FIG. 2. As shown in FIG. 10, operation 360 includes operations 1010 and 1020.

At operation 1010, the personalized communication module 206 can calculate a discounting factor based on the start date, the end date, and the last logon date. The start date and the end date can be received from the request at operation 310. The last logon date can be in the behavior data 216 that is accessed at operation 340.

At operation 1020, the personalized communication module 206 calculates the number of messages based on the discounting factor and the number of unique visitors. As previously described, FIG. 9 includes some of the techniques for calculating the number of messages based on the discounting factor, the number of unique visitors. In some instances, the calculation of the number of messages can be further based on the frequency cap.

FIG. 11 is a block diagram illustrating components of a machine 1100, according to some example embodiments, able to read instructions 1124 from a machine-readable medium 1122. (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device 130, 150 or may be connected (e.g., networked) to other machines. In a networked deployment, the machine 1100 may operate in the capacity of a server machine 110 or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine 1100 is illustrated, the term “machine” shall also be taken to include any collection of machines 1100 that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or another pointing instrument), a storage unit 1116, an audio generation device 1118 (e,g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's cache memory), or both, before or during execution thereof by the machine 1100. Accordingly, the main memory 1104 and the processor 1102 may be considered machine-readable media 1122 (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., Hypertext Transfer Protocol (HTTP)).

In some example embodiments, the machine 1100 may be a portable computing device, such as a smartphone or tablet computer, and may have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 1130 may be accessible and available for use by any of the modules described herein.

As used herein, the term “memory” refers to a machine-readable medium 1122 able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term. “machine-readable medium” should be taken to include a single medium or multiple media (e.g., a centralized or distributed database, or associated caches and servers) able to store instructions 1124. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly he taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1122 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 1102) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1102 or other programmable processor 1102. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 1102 configured by software to become a special-purpose processor, the general-purpose processor 1102 may be configured as respectively different special-purpose processors (e.g., comprising different hardware modules) at different times. Software (e.g., a software module) may accordingly configure one or more processors 1102, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1108) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1102 that are temporarily configured (e.g., by software) or permanently configured to perform the relevant operations. Whether temporarily or permanently configured, such processors 1102 may constitute processor-implemented modules that operate to perform one or more operations or functions described herein. As used herein, “processor-implemented module” refers to a hardware module implemented using one or more processors 1102.

Similarly, the methods described herein may be at least partially processor-implemented, a processor 1102 being an example of hardware. For example, at least some of the operations of a method may be performed by one or more processors 1102 or processor-implemented modules. As used herein, “processor-implemented module” refers to a hardware module in which the hardware includes one or more processors 1102. Moreover, the one or more processors 1102 may also operate to support performance of the relevant operations in a “cloud computing” environment or as a “software as a service” (SaaS). For example, at least some of the operations may be performed by a group of computers (as examples of machines 1100 including processors 1102), with these operations being accessible via a network 190 (e.g., the Internet) and via one or more appropriate interfaces (e.g., an application programming interface (API)).

The performance of certain operations may be distributed among the one or more processors 1102, not only residing within a single machine 1100, but deployed across a number of machines 1100. In some example embodiments, the one or more processors 1102 or processor-implemented modules may be located in a single geographic location (e.g., within a home environment, an office environment, or a server farm). In other example embodiments, the one or more processors 1102 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 1100. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 1100 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a request for a first advertisement campaign on a social network, the request having a member attribute and a time frame;
accessing member data from the social network;
determining a target group in the social network based on the member data and the member attribute;
accessing behavior data for the target group, the behavior data including a last logon date to the social network for a member;
calculating a number of unique visitors to the social network from the target group based on the member attribute, the time frame, and a frequency cap; and
forecasting, using a processor, a number of messages for the first advertisement campaign based on the calculated number of unique visitors, the behavior data, and the time frame.

2. The method of claim 1, wherein the time frame includes a start date and an end date, and wherein the forecasting includes:
calculating a discounting factor based on the start date, the end date, and the last logon date; and
calculating the number of messages based on the discounting factor and the number of unique visitors.

3. The method of claim 2, wherein the discounting factor is further based on the received member attribute.

4. The method of claim 1, wherein the frequency cap corresponds to a maximum number of messages that a member receives during a predetermined amount of time.

5. The method of claim 1, wherein the frequency cap is based on the member attribute.

6. The method of claim 1, wherein the request includes a geographic location, and wherein the target group is determined by:
determining a number of members living in the geographic location based on the assessed member data;
calculating a ratio of members in the social network having the member attribute based on the accessed member data; and
multiplying the number of members living in the geographic location by the ratio of members in the social network having the attribute.

7. The method of claim 6, wherein the calculated ratio is based on historical data of members living in the geographic location having the attribute.

8. The method of claim 1, wherein the time frame includes a first start date, and wherein calculating the number of unique visitors includes:
calculating the number of unique visitors to the social network from the target group based on the frequency cap;
accessing a similar member attribute from a second advertisement campaign, the second advertisement campaign having a second start date before the first start date of the first campaign;
identifying a degree of similarity between the similar member attribute and the received member attribute;
in response to the identification, reducing the number in the target group based on the first start date, the second start date; and
updating the calculated number of unique visitors based on the reduced number in the target group.

9. The method of claim 1, wherein the number of unique visitors is a number of daily unique visitors.

10. The method of claim 1, further comprising:
causing a presentation of the number of messages fur the first advertisement campaign on a display of a device.

11. The method of claim 1, wherein the member attribute is a job title.

12. The method of claim 1, wherein the member attribute is a job skill.

13. The method of claim 1, wherein the frequency cap is predetermined by the social network.

14. The method of claim 1, wherein the behavior data includes mobile device usage data of a member, and wherein the number of potential members corresponds to mobile device users.

15. The method of claim 1, wherein the behavior data includes desktop device usage data of a member, and wherein the number of potential members corresponds to desktop device users.

16. A social network system comprising:
a first database having profile data;
a second database having behavior data, the behavior data including a last logon date to a social network for a member;
one or more processors configured by a personalized communication module to:
receive a request for a first advertisement campaign on a social network, the request having a member attribute and a time frame;
access profile data from the first database;
determine a target group in the social network based on the profile data and the member attribute;
access the behavior data for the target group from the second database;
calculate a number of unique visitors to the social network from the target group based on the member attribute, the time frame, and a frequency cap; and
forecast a number of messages for the first advertisement campaign based on the calculated number of unique visitors, the behavior data, and the time frame.

17. The system of claim 16, wherein the personalized communication module is further configured to:
calculate a discounting factor based on the start date, the end date, and the last logon date; and
calculate the number of messages based on the discounting factor and the number of unique visitors.

18. The system of claim 16, wherein the personalized communication module is further configured to:
determine a number of members living in the geographic location based on the assessed member data;
calculate a ratio of members in the social network having the member attribute based on the accessed member data; and
multiply the number of members living the geographic location by the ratio of members in the social network having the attribute.

19. The system of claim 16, wherein the personalized communication module is further configured to:
calculate the number of unique visitors to the social network from the target group based on the frequency cap;
access a similar member attribute from a second advertisement campaign, the second advertisement campaign having a second start date before the first start date of the first campaign;
identify a degree of similarity between the similar member attribute and the received member attribute;
in response to the identification, reduce the number in the target group based on the first start date, the second start date; and
update the calculated number of unique visitors based on the reduced number in the target group.

20. A non-transitory machine-readable storage medium comprising instructions that, when executed by one or more processors of a machine, cause the machine to perform operations comprising:
receiving a request for a first advertisement campaign on a social network, the request having a member attribute and a time frame;
accessing member data from the social network;
determining a target group in the social network based on the member data and the member attribute;
accessing behavior data for the target group, the behavior data including a last logon date to the social network for a member;
calculating a number of unique visitors to the social network from the target group based on the member attribute, the time frame, and a frequency cap; and
forecasting, using a processor, a number of messages for the first advertisement campaign based on the calculated number of unique visitors, the behavior data, and the time frame.
